(19) United States
(12) Patent Application Publication
(10) Pub. No.: US 2026/0360094 A1
(43) Pub. Date: Nov. 12, 2026

(54) SIGNALLING SEMANTIC PERCEPTION IN AUGMENTED REALITY-BASED SERVICE

(71) Applicant: Tencent America LLC, Palo Alto, CA (US)

(72) Inventor: Stephan WENGER, Hillsborough, CA (US)

(73) Assignee: Tencent America LLC, Palo Alto, CA (US)

(21) Appl. No.: 19/654,371

(22) Filed: Apr. 21, 2026

Related U.S. Application Data
(60) Provisional application No. 63/804,595, filed on May 12, 2025.

(51) Int. Cl. G06T 19/00; G06T 17/00; G06V 20/20; G06V 20/70

(52) U.S. Cl. CPC G06T 19/006; G06T 17/00; G06V 20/20; G06V 20/70

(57) ABSTRACT

In a method for computing semantic perception information in a media application server (Media AS), at least one piece of sensor information is received from a user equipment (UE) comprising at least one sensor. The at least one piece of sensor information is captured by the at least one sensor and associated with a three-dimensional (3D) space. A representation of the 3D space including at least one object is generated based on the received at least one piece of sensor information. At least one piece of semantic perception information of the at least one object is generated.

### CROSS-REFERENCE TO RELATED APPLICATION

The present application claims the benefit of priority to U.S. Provisional Application No. 63/804,595, “SIGNALLING SEMANTIC PERCEPTION IN AUGMENTED REALITY-BASED SERVICE” filed on May 12, 2025, which is incorporated by reference herein in its entirety.

### TECHNICAL FIELD

The present disclosure describes aspects generally related to spatial computing and scene rendering for augmented reality (AR) services.

### BACKGROUND

Extended reality (XR) spatial computing encompasses a set of functions which process sensor data to generate information about a world three-dimensional (3D) space surrounding an AR user. The set of functions include relocalization (e.g., establishing positions of users and objects within the world 3D space), anchoring, 3D Model construction, segmentation and labeling (e.g., semantic perception), light extraction, and real object removal. The set of functions are achieved through a combination of advanced sensors, cameras, and algorithms that enable devices (e.g., AR devices) to understand and interact with the 3D space around the devices.

Semantic perception may refer to use of artificial intelligence and machine learning (AI/ML) techniques to interpret and understand a real-world environment captured by AR devices. Semantic perception enables identification, classification, and contextual understanding of objects, surfaces, and scenes in a two-dimensional (2D) space and/or a 3D space.

Semantic perception may be required in some systems or services to understand meaning of an environment. While functions like world tracking and 3D reconstruction provide spatial data (e.g., surfaces, meshes, and positions), semantic perception adds contextual intelligence by identifying and classifying objects, surfaces, and scenes. An interoperable format may be required to represent semantic perception. Related examples, study spatial computing for AR services, yet do not include semantic perception information.

### SUMMARY

Aspects of the disclosure include bitstreams, methods, and apparatuses for spatial computing and scene rendering. In some examples, an apparatus for spatial computing and scene rendering includes processing circuitry.

Aspects of the disclosure include a method for computing semantic perception information in a media application server (Media AS). In the method, at least one piece of sensor information is received from a user equipment (UE) comprising at least one sensor. The at least one piece of sensor information is captured by the at least one sensor and associated with a three-dimensional (3D) space. A representation of the 3D space including at least one object is generated based on the received at least one piece of sensor information. At least one piece of semantic perception information of the at least one object is generated.

In an aspect, the at least one piece of semantic perception information includes at least one of a semantic map, a label, or a scene graph.

In an aspect, the at least one piece of semantic perception information is transmitted to the UE as a part of transmission of the representation of the 3D space.

In an aspect, the UE renders the at least one object using the at least one piece of semantic perception information.

In an aspect, the at least one object includes a plurality of objects in the 3D space. The at least one piece of semantic perception information includes a semantic map. The semantic map corresponds to a structured representation of the plurality of objects in the 3D space and spatial relationships of the plurality of objects in the 3D space.

In an aspect, the at least one object includes a plurality of objects in the 3D space. The at least one piece of semantic perception information includes a semantic map. The semantic map includes an array of the plurality of objects in the 3D space. Each of the plurality of objects includes at least one of a label, a position, or a confidence score.

In an aspect, the at least one piece of semantic perception information includes a label. The label corresponds to a semantic label assigned to the at least one object in the 3D space.

In an aspect, the at least one object includes a plurality of objects in the 3D space. The at least one piece of semantic perception information includes a plurality of labels assigned to the plurality of objects. The plurality of labels is formatted in a string array. The string array includes a mapping between a plurality of indices and the plurality of labels assigned to the plurality of objects in the 3D space.

In an aspect, the at least one object includes a plurality of objects in the 3D space. The at least one piece of semantic perception information includes a scene graph. The scene graph corresponds to a graph of the plurality of objects in the 3D space with semantic relationships. The semantic relationships includes at least one of adjacency information or containment information.

In an aspect, the at least one object includes a plurality of objects in the 3D space. The at least one piece of semantic perception information includes a scene graph. The scene graph includes a plurality of nodes representing the plurality of objects in the 3D space and a plurality of edges representing spatial or semantic relationships of the plurality of objects.

In an aspect, the at least one piece of sensor information is retrieved, by a source manager of the UE, from an extended reality (XR) runtime of the UE. The at least one piece of sensor information is transmitted, by the source manager of the UE, to a media access function of the UE. The at least one piece of sensor information is transmitted, by the media access function, to the Media AS.

Aspects of the disclosure also provide an apparatus for computing semantic perception information. The apparatus for computing semantic perception information includes processing circuitry configured to implement any of the described methods for computing semantic perception information.

Aspects of the disclosure also provide a non-transitory computer-readable storage medium stores instructions which, when executed by at least one processor of a media application server, cause the at least one processor to perform any of the described methods.

Technical solutions of the disclosure include methods and apparatuses to apply a semantic perception function to enhance spatial computing and scene rendering in AR environments. In an example, at least one piece of sensor information is received from a user equipment (UE) comprising at least one sensor. The at least one piece of sensor information is captured by the at least one sensor and associated with a three-dimensional (3D) space. A representation of the 3D space including at least one object is generated based on the received at least one piece of sensor information. At least one piece of semantic perception information of the at least one object is generated. Therefore, accuracy of scene rendering based on spatial computing is enhanced by applying the semantic perception function.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of an extended reality (XR) baseline terminal architecture according to some aspects of the disclosure.

FIG. 2 is a schematic illustration of an example of a spatial computing architecture according to some aspects of the disclosure.

FIG. 3 is a schematic illustration of an example of a call flow for spatial computing session setup and operation according to some aspects of the disclosure.

FIG. 4 shows a flow chart outlining a method for rendering an AR scene according to some aspects of the disclosure.

FIG. 5 is a schematic illustration of a computer system in accordance with an aspect.

### DETAILED DESCRIPTION

Aspects of the disclosure include a format for defining a semantic perception function that may be used to enhance spatial computing in AR environments. In an example, the semantic perception function is defined by one or more of three parameters: a semantic map which may list recognized objects and spatial relationships (e.g., annotated meshes, point clouds, or pixels) of the recognized objects; a list of labels describing possible values of the recognized (or detected) objects; and/or a scene graph identifying the detected objects and defining the spatial or semantic relationships of the detected objects.

Aspects of the disclosure include, in a spatial description format for a three-dimensional (3D) model or a scene, a semantic perception data structure that may include at least one of a semantic map, one or more labels, or a scene graph. The semantic map may be a structured representation of recognized objects and spatial relationships of the recognized objects. A label may refer to a string including a unique identifier of an object or a region. A scene graph may be a graph of objects with their semantic relationships (e.g., adjacency and/or containment).

XR spatial computing requires accurately localizing an AR device worn by an end-user in relation to a spatial coordinate system of a real-world space. Vision-based localization systems reconstruct a sparse spatial mapping of the real-world space in parallel (e.g., simultaneous localization and mapping (SLAM)). Beyond the localization within a world coordinate system, which may be based on a sparse spatial map, dense spatial mapping of objects is also performed in order to place 3D objects on real surfaces and provides the ability to occlude objects behind surfaces, do physics-based interactions based on surface properties, provide navigation functions, or provide a visualization of the surface.

In an aspect, for understanding and perceiving a scene semantically, machine-learning and/or artificial intelligence may be used to provide context for the observed scene.

An output of spatial computing may include spatial mapping information that is organized in a data structure, such as a data structure called XR Spatial Description, for storing and exchanging the spatial mapping information. Some spatial computing functions may also take an XR spatial description as an input and may result in updates to the XR spatial description. Spatial computing functions may include data exchange and require a network architecture.

An AR device may provide sensor data to a spatial computing function to create or update spatial mapping information. The AR device may also access the spatial computing function to retrieve different spatial mapping information depending on needs of the XR application.

The spatial computing functions may run locally on the AR device or may be executed remotely on a cloud or on an edge in a spatial computing server accessed through dedicated interfaces.

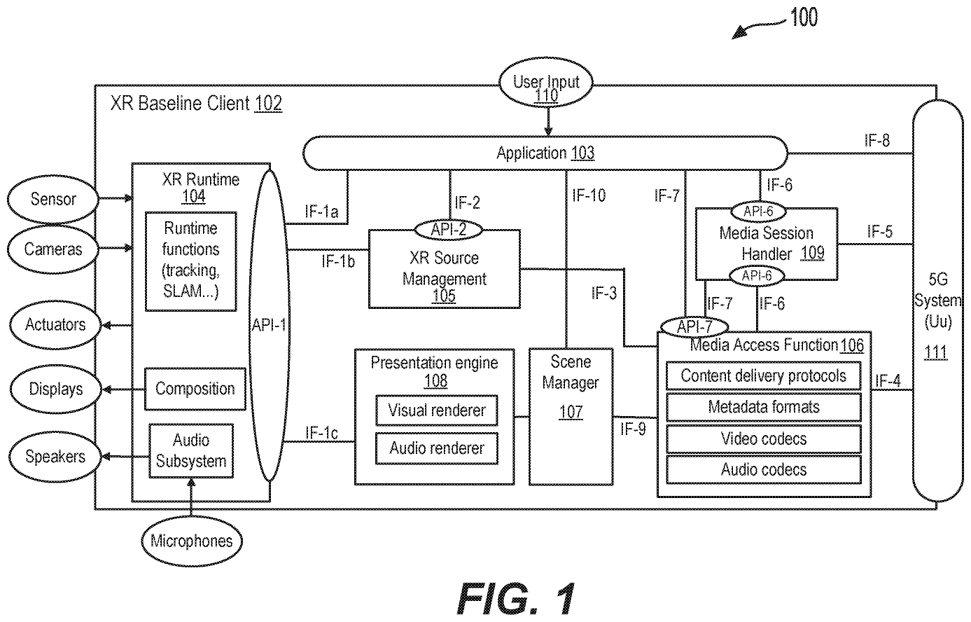

FIG. 1 is a schematic illustration of an example of an XR baseline terminal architecture (100) for spatial computing according to some aspects of the disclosure.

As shown in FIG. 1, the XR baseline terminal architecture (100) may include a XR baseline client (102). The XR baseline client (102) may include a XR application (or application) (103), an XR runtime (104), an XR source management (105), a media access function (106), a scene manager (107), a presentation engine (108), and a media session handler (109).

The XR application (103) may include a software application that receives a user input (110) of a user and integrates an audio-visual content into a real-world environment of the user. The XR runtime (104) may include a set of functions that interface with a platform to perform commonly required operations, such as accessing a controller/peripheral state, getting current and/or predicted tracking positions, performing spatial computing, as well as submitting (i) rendered frames to a display processing unit and (ii) a rendered audio to speakers with a late stage re-projection to a latest pose. In an example, the set of functions are provided by an XR device (or AR device) to the XR application to support XR experiences. The XR runtime (104) may include one or more spatial computing functions that can be performed locally on the XR device.

The XR source management (105) may include management of data sources provided through the XR runtime (104), such as microphones, cameras, trackers, etc, for instance, making the data sources available to the XR application (103) or providing the data sources to the media access function (106) for sending the data sources in an uplink of a 5G system (111). In an example, the XR source management (105) is responsible for gathering timed metadata, such as sensor data and pre-processed sensor information, and sending the timed metadata to an application server (AS).

The media access function (106) may include a set of functions that enable access to media and other XR-related data that is needed in the scene manager (107) or the XR runtime (104) to provide an XR experience as well to create delivery formats for information provided by the XR source management (105). In an aspect, the media access function (106) is responsible for delivery of metadata or local media to the spatial computing functions in an application server (AS).

The scene manager (107) may include a set of functions that support the application (103) in arranging logical and spatial representation of a multisensorial scene based on support from the XR runtime (104). The presentation engine (108) may include a set of composite renderers (e.g., a visual render and an audio render), rendering components of scenes, based on an input from the scene manager (107). In an example, the scene manager (107) and the presentation engine (108) are responsible for parsing of a description (e.g., XR spatial description) that is returned as an output from one or more spatial computing functions. The spatial computing functions may be provided by the AS. The scene manager (107) and the presentation engine (108) are also configured to set up and manage a XR session with the XR runtime (104).

The media session handler (109) may include a set of functions responsible for handling all 5G control plane operations, such as requesting network assistance, discovering and allocating edge resources, etc. The media session handler (109) may be realized as a 5G-RTC MSH, 5 GMS Media Session Handler, or any other function.

In an aspect, functional blocks shown in FIG. 1 may be integrated together via interfaces. Interfaces may include application programming interfaces (APIs) and/or data formats, collectively serving as a contract between parties on each side of the interface.

In an example of FIG. 1, the XR baseline client (102) includes a plurality of interfaces, such as interfaces IF-1, IF-2, IF-3, IF-4, IF-5, IF-6, IF-7, IF-8, IF-9, and IF-10. IF-1 includes an interface IF-la between the XR runtime (104) and the application (103), an interface IF-1b between the XR runtime (104) and the XR source management (105), and an interface IF-1c between the XR runtime (104) and the presentation engine (108). In an example, the interfaces IF-la, IF-1b, and IF-1c are implemented as an application programming interface (API), such as API-1, that exposes functions provided by the XR runtime (104). An example of the API is Khronos OpenXR API. IF-2 may describe functions exposed by the XR source management (105). The functions may be accessed and controlled by the XR application (103), or other functions in a device (e.g., an AR device or an XR device). In an example, IF-2 is implemented as API-2. IF-3 is defined between the XR source management (105) and the media access function (MAF) (106). IF-3 may be configured to provide serialized information accessible on (or originating from) the XR runtime (104) to the MAF (106). IF-4 is defined between the media access function (106) and the 5G System (111) for transmitting user plane data, such as application data or other graphics data needed by the XR application (103). IF-5 is defined between a user equipment (UE) and the 5G System (111) and configured to implement control sessions. In an example, the UE includes one of an AR device, an extended reality (XR) device, and an edge computing device (e.g., a media application server).

An example of IF-5 is a RTC-5 interface as defined 3GPP TS 26.506. IF-6 connects the media session handler (109) and the application (103) and/or the MAF (106). IF-6 offers tools for the application (103) and/or the MAF (106) to activate a 5G media functionality, such as a network assistance and an edge resource discovery. In an example, IF-6 is realized through an API, such as API-6. IF-7 lies between the XR application (103) and the media access function (106) to configure media access. IF-7 may be implemented as an API, such as API-7, that exposes functions of the MAF (106). IF-8 is an interface that allows the XR application (103) to make use of connectivity of the 5G system (111). IF-9 is an interface between the scene manager (107) and the MAF (106). IF-10 is defined between the scene manager (107) and the XR application (103).

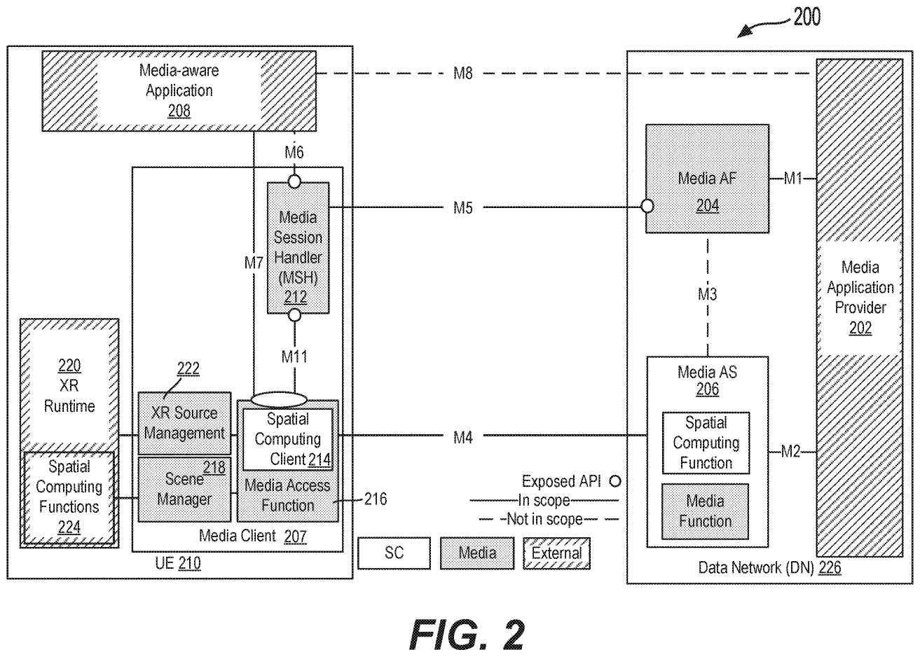

FIG. 2 is a schematic illustration of an example of a spatial computing architecture (200) (also referred to as architecture (200)) based on a user equipment (UE) (210) and a data network (DN) (226).

As shown in FIG. 2, the spatial computing architecture (200) includes a plurality of network functions and UE entities. For example, the architecture (200) includes a media application provider (202) that is configured to offer a spatial computing service. The architecture (200) includes a media application function (media AF) (204) that is responsible for negotiation of a spatial computing service session between a media application server (media AS) (206) and a media client (207).

The media AS (206) included in the architecture (200) is responsible for establishing the spatial computing session with the media client and monitoring an edge resource usage of the media application server (206). The media AS (206) may host a spatial computing function that manages and runs one or more other spatial computing functions.

The architecture (200) includes a media-aware application (or media application) (208) that includes one or more applications running on the UE (210). The architecture includes a media session handler (MSH) (212). The MSH (212) is located on the UE (210) and configured to manage control plane signalling with the media AF (204) to establish a spatial computing session.

The architecture (200) includes a spatial computing client (SCC) (214) that is responsible for discovering UE spatial computing capabilities and negotiating with the media AS (206) to agree on a spatial computing process.

The architecture (200) includes a media access function (216) (e.g., a media access function defined in TS 26.506), configured to send sensor data and receive XR spatial descriptions from the media AS (206).

In an example, the sensor data includes images captured by an AR device, inertial measurement unit (IMU) data, a pose of the AR device, depth maps (e.g., image or texture), global navigation satellite system (GNSS) data, depth data (e.g., LiDAR data), mesh data captured by the AR device, or the like.

The architecture (200) includes a scene manager (218). The scene manager (218) may include a set of functions that supports an application in arranging a logical and spatial representation of a multisensorial scene based on support from a XR runtime (220). The scene manager (218) may compose a scene using XR spatial description data.

The architecture (200) includes XR source management (222) that includes management of data sources provided through the XR runtime (220). The XR source management may retrieve the sensor data (and/or other data, such as camera data, microphone data) from the XR runtime (220) and provides the sensor data to the media access function (216).

The XR runtime (220) of the architecture (200) includes a set of functions provided by a XR device to the media application (208) to create XR experiences. The XR runtime (220) may include one or more spatial computing functions (224).

Still referring to FIG. 2, the architecture (200) may include a plurality of interfaces, such as interfaces M1-M8 and M11. In an aspect, the media application provider (202) may provide a spatial computing service through the M-1 interface. In an aspect, signaling as well as data delivery between media access function (216) and the media AS (206) is though the M-4 interface. In an aspect, the MSH (212) and the media AF (204) may exchange spatial computing configuration related information through the M-5 interface. In an aspect, the spatial computing client (214) may discover the spatial computing capabilities of the UE through the M-7 interface. In an aspect, the M11 interface may be used to convey quality of service (QoS) allocation and quality of experience (QoE) information related to spatial computing functions between the MSH (212) and the media access function (216).

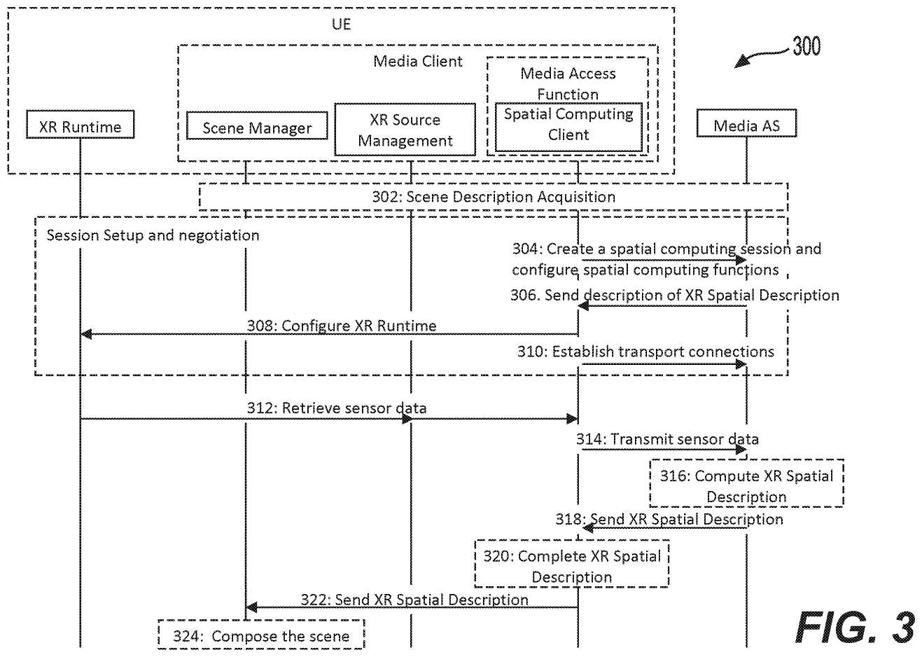

FIG. 3 is a schematic illustration of an example of a call flow (300) for spatial computing session setup and operation.

As shown in FIG. 3, at step (302), a scene manager, such as the scene manager (218), acquires scene description information and discovers needed spatial computing functions for XR experience.

At step (304), a media client, such as the media client (207), discovers a media AS (e.g., the media AS (206)) and sets up a connection to the media AS. The media client may provide information about spatial computing capabilities of a UE (e.g., UE (210)) to configure spatial computing functions in the media AS. In an example, configuration of the spatial computing functions may include a process of setting up, adjusting, or establishing parameters, settings, and operational characteristics of the spatial computing functions within the media application server (media AS).

At step (306), in response to step (304), the media AS (e.g., media AS (206)) creates and transmits (i) a description of a XR spatial description format, (ii) configuration data of the spatial computing functions, and (iii) an input received from a spatial computing client (e.g., the spatial computing client (214)) to the media client.

At step (308), a XR runtime (e.g., XR runtime (220)) is configured. Configuration of the XR runtime aims to provide sensor data (or other data, such as camera data and microphone data) that is needed for the spatial computing functions configured in the media AS in step (304).

At step (310), the spatial computing client requests an instantiation of pipelines for XR spatial description from the media access function, which in turn establishes a connection to the media AS.

At step (312), a XR source manager (e.g., source manager (222)) retrieves the sensor data from the XR runtime and provides the sensor data to the media access function (e.g., the media access function (216)).

At step (314), the media access function sends the sensor data to the media AS.

At step (316), the media AS uses the sensor data to invoke the spatial computing functions and compute the XR spatial description. In an example, an output of spatial computing based on the spatial computing functions may include spatial mapping information that is organized in a data structure, such as a data structure called XR spatial description, for storing and exchanging the spatial mapping information.

At step (318), the media AS transmits the generated XR spatial description to the media access function.

At step (320), the spatial computing client may complete the XR spatial description using the sensor data.

At step (322), the spatial computing client provides the XR spatial description to a scene manager (e.g., scene manager (218)).

At step (324), the scene manager composes a scene using the XR spatial description.

Table 1 shows a plurality of spatial computing functions and output data formats of the spatial computing functions.

TABLE 1
Spatial computing functions and associated output data

| | | | | Possible |
|---|---|---|---|---|
| Function | Data | Description | Format Example | Representation |
| World | Feature Map | Features to compute | Array of features | |
| Tracking | | a pose in XR Space. | | |
| | Feature | 3D point associated | SIFT (Scale | Typically, a |
| | | with a descriptor, the | Invariant Feature | vector of 128 |
| | | descriptor format | Transform) | floats. |
| | | depends on the | ORB - Oriented | Typically, a 32- |
| | | feature type. | FAST Rotated | bit descriptor. |
| | | | BRIEF (Binary | |
| | | | descriptor) | |
| | | | BRIEF - Binary | Typically, 32- |
| | | | Robust | bit descriptor. |
| | | | Independent | |
| | | | Elementary | |
| | | | Features) | |
| | | | FREAK - Fast | Typically, 64- |
| | | | Retina Keypoint | bit descriptor. |
| | | | SURF - Speeded- | Typically, |
| | | | Up Robust | vector of 64-bit |
| | | | Features | or 128-bit |
| | | | | floats. |
| Relocalization | Pose | Pose of the AR | Position: 3D | Position: 3 |
| | | device in XR Space | vector | floating point |
| | | | Orientation: | values. |
| | | | quaternion | Orientation: 4 |
| | | | | floating point |
| | | | | values |
| | XR_space_id | An identifier for the | String | |
| | | XR Space used as a | | |
| | | reference. | | |
| Anchoring | Id | An identifier of the | String | |
| | | new trackable (when | | |
| | | the anchoring | | |
| | | function is invoked | | |
| | | by a producer). | | |
| | Pose | Pose of the anchor in | Position: 3D | Position: 3 |
| | | relation to the device | vector | floating point |
| | | according to a | Orientation: | values. |
| | | trackable (when the | quaternion | Orientation: 4 |
| | | anchoring function is | | floating point |
| | | invoked by a | | values |
| | | consumer). | | |
| 3D Model | Model | 3D model(s) of | Non-segmented | OBJ, STL, |
| Construction | | surrounding space. | model (e.g., point | PLY, FBX, |
| | | | cloud, mesh | glTF |
| | | | with/without | |
| | | | attributes) | |
| | | | Segmented model | glTF, USD |
| Semantic | Semantic Map | A structured | Graph, list or | Each object |
| Perception | | representation of | array of labelled | includes a label |
| | | recognized objects | objects | (string), |
| | | and their spatial | | position (3D |
| | | relationships | | vector), and |
| | | | | optionally a |
| | | | | confidence |
| | | | | score. |
| | Labels | Set of semantic labels | String array | [“chair”, |
| | | assigned to detected | | “table”, “wall”, |
| | | objects or regions | | “car”, “door”, |
| | | | | . . .] |
| | Scene Graph | Graph of objects with | Nodes represent | JSON, RDF, or |
| | | semantic | objects; edges | MPEG-I SD |
| | | relationships (e.g., | represent spatial | |
| | | adjacency, | or semantic | |
| | | containment) | relationship | |
| Collider | Colliders | Set of colliders (not | Array of colliders | |
| Generation | | combined with | | |
| | | associated objects). | | |
| | Collider | A collider object. | Primitive (e.g., | |
| | | | sphere with | |
| | | | radius) | |
| | | | Mesh | OBJ, STL, |
| | | | | FBX |
| | Colliders | Part of description of | Hierarchical node | MPEG-I SD, |
| | | the 3D Model (when | graph | USD |
| | | combined with | | |
| | | associated objects). | | |
| Segmentation | Objects | A list of 3D objects | Array or a | |
| and Labeling | | resulting from the | hierarchical node | |
| | | segmentation and | graph. | |
| | | labeling function. | | |
| | Object | A 3D object in the | | |
| | | captured world. | | |
| | Mesh | Segmented object. | Mesh | |
| | Label | Label of segmented | String | |
| | | object. | | |
| Light | Lights | Set of extracted lights | Array | |
| Extraction | Light | A description of a | Object | For point light, |
| | | light source that | | the parameters |
| | | includes a set of | | include: pose, |
| | | parameters that | | intensity, color, |
| | | depend on the type of | | and range. |
| | | the light. Possible | | |
| | | types include: point, | | |
| | | directional, area, | | |
| | | spot, texture-based, | | |
| | | or image-based light. | | |
| Real Object | Objects | A set of textured 3D | Mesh + texture | OBJ, STL, |
| Removal | | objects. | | PLY, FBX, |
| | | | | glTF |
| | Images | Images with | | PNG, TIFF, |
| | | transparency. | | TGA, BMP |

As shown in Table 1, the spatial computing functions include a world tracking function, a relocalization function, an anchoring function, a 3D model reconstruction function, a segmentation and labelling function, a collider generation function, a light extraction function, a real object removal function, and a semantic perception function.

A semantic perception format associated with the semantic perception function may be built upon an output of other spatial computing functions, such as the segmentation and labelling function (e.g., a segmentation and labelling function as defined in clause 4.2.6 of aforementioned 3GPP Draft TR 26.819), and the 3D model reconstruction function (e.g., a 3D model reconstruction function as defined in clause 4.2.5 of 3GPP Draft TR 26.819). The semantic perception function may enhance the XR experience by enabling applications to reason about the environment, support intelligent interactions, and adapt content based on recognized context. The semantic perception function may be performed locally on the AR device or remotely on edge/cloud servers, depending on computational complexity and latency requirements. An output of the semantic perception function may be integrated into the XR spatial description and used by other spatial computing functions or the scene manager.

In an aspect, semantic perception information of the semantic perception function may contain one or more parameters. The one or more parameters may include a semantic map, labels, and a scene graph. The semantic map may be a structured representation of recognized objects and spatial relationships of the recognized objects. The labels may indicate semantic categories assigned to the detected (or recognized) objects or regions (e.g., “chair”, “table”, or “car”). The scene graph may be a graph-based representation of objects and semantic or spatial relationships of the objects (e.g., adjacency and/or containment).

In an aspect, the semantic map is a spatial representation of the environment in which each region, surface, or object may be annotated with meaningful semantic labels. The semantic map may combine geometric data in a form of, for example, point clouds, meshes, or voxel grids, with contextual information that may identify a corresponding representation of each part of the environment (e.g., “floor”, “wall”, or “table”). Contextual information may be represented by a string of characters or other mechanisms (such as an enum) depending on a service or an application. In an example, an enum (also referred to as enumeration) is a data type used in programming and data representation that includes, or consists of, a fixed set of named constant values. According to a string approach, the contextual information may be stored as free-form text (e.g., scene_indoor or user_standing). According to an enum approach, the contextual information may be stored as one of a predefined set of values (e.g., INDOOR, OUTDOOR, MIXED), which provides more structure and reduces a risk of errors from inconsistent naming.

Enriched spatial data provided by the semantic map may allow AR systems to understand not only a shape and a layout of the environment but also a function and an identity of components of the environment, and act on the environment accordingly.

For example, within a scene, if an object is identified as “floor”, an AR system may represent the floor as provided in the spatial data, or the AR system may render the floor differently based on user preferences. Those preferences may be set by a user and may be applied to more than one scene. For example, one user may prefer a green grass-textured floor over other floor representations. Using semantic information including the semantic map, the user's AR system can be instructed to render the floor as green and grass-textured. Semantic maps may be useful for navigation, content placement, and scene understanding, as the semantic maps may provide a labelled view of a physical world that is interpreted by both machines and humans.

A label may be a textual or symbolic identifier assigned to objects or regions within a scene to describe semantic categories of the objects or the regions. Labels, such as “chair”, “screen”, or “door”, may provide a lightweight and interpretable way to classify elements in the environment. The labels may be useful for enabling context-aware interactions, allowing applications to respond differently based on the type of object being referenced. Labels may also be localized for multilingual support or mapped to ontologies for domain-specific reasoning. In machine learning workflows, labels may serve as both training targets and inference outputs, which makes the labels a foundational component of semantic perception systems.

A scene graph (or object graph) may be a structured representation of relationships between semantically identified objects in a scene. Each object may be represented as a node, and connections (or edges) between objects may define spatial or semantic relationships, such as “on top of”, “next to”, or “part of”. This graph-based model enables reasoning about the environment by capturing not just what objects are present, but how the objects relate to one another. Object graphs may support complex queries, hierarchical scene management, and intelligent behavior in AR applications. The object graphs may be extensible, allowing additional attributes, such as confidence scores, timestamps, or user annotations to be included for richer context.

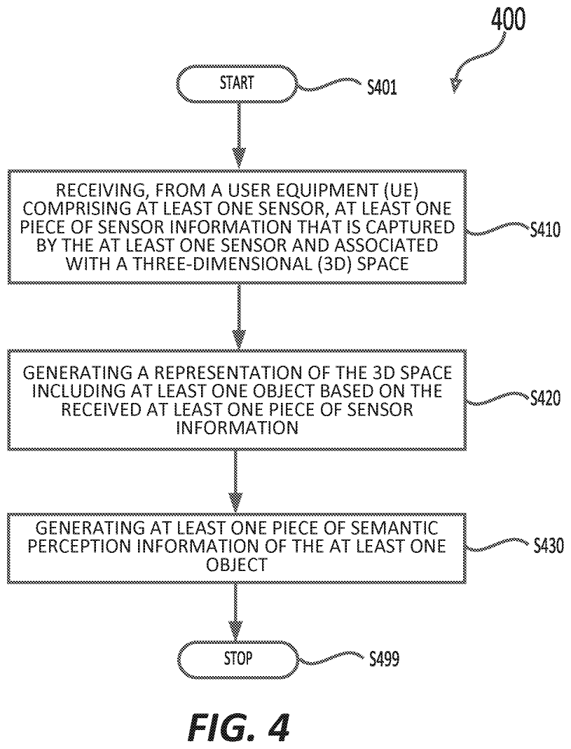

FIG. 4 shows a flow chart outlining a process (400) according to an aspect of the disclosure. The process (400) can be used in a Media AS. In various aspects, the process (400) is executed by processing circuitry, such as the processing circuitry that performs functions of the Media AS (206). In some aspects, the process (400) is implemented in software instructions, thus when the processing circuitry executes the software instructions, the processing circuitry performs the process (400). The process starts at (S401) and proceeds to (S410).

At (S410), at least one piece of sensor information is received from a user equipment (UE) comprising at least one sensor. The at least one piece of sensor information is captured by the at least one sensor and associated with a three-dimensional (3D) space.

At (S420), a representation of the 3D space including at least one object is generated based on the received at least one piece of sensor information.

At (S430), at least one piece of semantic perception information of the at least one object is generated.

In an aspect, the at least one piece of semantic perception information includes at least one of a semantic map, a label, or a scene graph.

In an aspect, the at least one piece of semantic perception information is transmitted to the UE as a part of transmission of the representation of the 3D space.

In an aspect, the UE renders the at least one object using the at least one piece of semantic perception information.

In an aspect, the at least one object includes a plurality of objects in the 3D space. The at least one piece of semantic perception information includes a semantic map. The semantic map corresponds to a structured representation of the plurality of objects in the 3D space and spatial relationships of the plurality of objects in the 3D space.

In an aspect, the at least one object includes a plurality of objects in the 3D space. The at least one piece of semantic perception information includes a semantic map. The semantic map includes an array of the plurality of objects in the 3D space. Each of the plurality of objects includes at least one of a label, a position, or a confidence score.

In an aspect, the at least one piece of semantic perception information includes a label. The label corresponds to a semantic label assigned to the at least one object in the 3D space.

In an aspect, the at least one object includes a plurality of objects in the 3D space. The at least one piece of semantic perception information includes a plurality of labels assigned to the plurality of objects. The plurality of labels is formatted in a string array. The string array includes a mapping between a plurality of indices and the plurality of labels assigned to the plurality of objects in the 3D space.

In an aspect, the at least one object includes a plurality of objects in the 3D space. The at least one piece of semantic perception information includes a scene graph. The scene graph corresponds to a graph of the plurality of objects in the 3D space with semantic relationships. The semantic relationships includes at least one of adjacency information or containment information.

In an aspect, the at least one object includes a plurality of objects in the 3D space. The at least one piece of semantic perception information includes a scene graph. The scene graph includes a plurality of nodes representing the plurality of objects in the 3D space and a plurality of edges representing spatial or semantic relationships of the plurality of objects.

In an aspect, the at least one piece of sensor information is retrieved, by a source manager of the UE, from an extended reality (XR) runtime of the UE. The at least one piece of sensor information is transmitted, by the source manager of the UE, to a media access function of the UE. The at least one piece of sensor information is transmitted, by the media access function, to the Media AS.

Then, the process proceeds to (S499) and terminates.

The process (400) can be suitably adapted. Step(s) in the process (400) can be modified and/or omitted. Additional step(s) can be added. Any suitable order of implementation can be used.

In an aspect, a non-transitory computer-readable storage medium is provided.

The non-transitory computer-readable storage medium stores instructions which, when executed by at least one processor of a media application server, cause the at least one processor to perform a method for computing semantic perception information in the media application server. In the method, at least one piece of sensor information is received from a UE comprising at least one sensor. The at least one piece of sensor information is captured by the at least one sensor and associated with a 3D space. A representation of the 3D space including at least one object is generated based on the received at least one piece of sensor information. At least one piece of semantic perception information of the at least one object is generated.

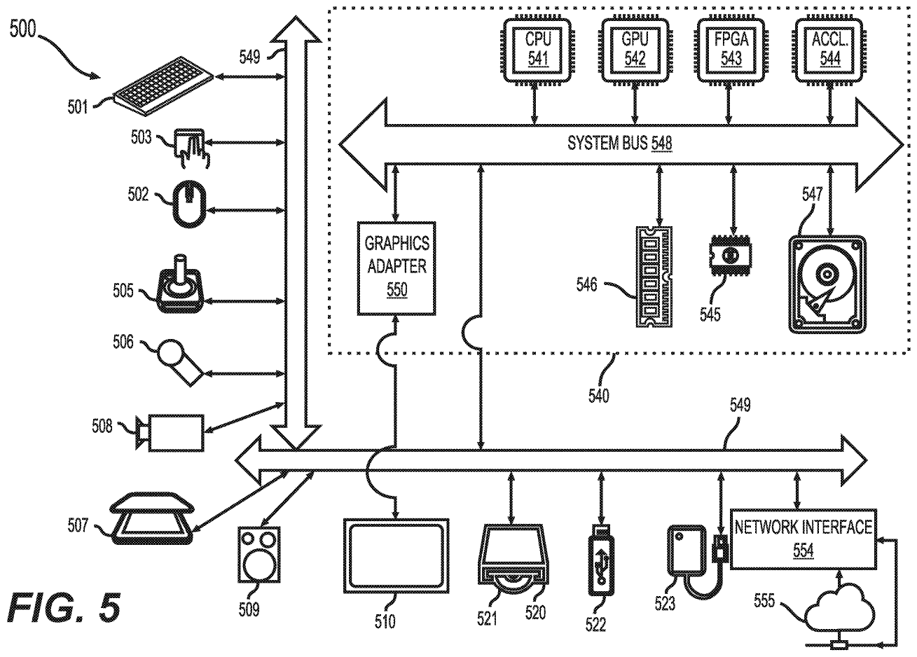

The techniques described above can be implemented as computer software using computer-readable instructions and physically stored in one or more computer-readable media. For example, FIG. 5 shows a computer system (500) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 5 for computer system (500) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (500).

Computer system (500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (501), mouse (502), trackpad (503), touch screen (510), data-glove (not shown), joystick (505), microphone (506), scanner (507), camera (508).

Computer system (500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (510), data-glove (not shown), or joystick (505), but there can also be tactile feedback devices that do not serve as input devices), audio output devices (such as: speakers (509), headphones (not depicted)), visual output devices (such as screens (510) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (500) can also include human accessible storage devices and their associated media such as optical media including CD/DVD ROM/RW (520) with CD/DVD or the like media (521), thumb-drive (522), removable hard drive or solid state drive (523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (500) can also include an interface (554) to one or more communication networks (555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attach to certain general purpose data ports or peripheral buses (549) (such as, for example USB ports of the computer system (500)); others are commonly integrated into the core of the computer system (500) by attachment to a system bus as described below (for example Ethernet interface into a PC computer system or cellular network interface into a smartphone computer system). Using any of these networks, computer system (500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (540) of the computer system (500).

The core (540) can include one or more Central Processing Units (CPU) (541), Graphics Processing Units (GPU) (542), specialized programmable processing units in the form of Field Programmable Gate Arrays (FPGA) (543), hardware accelerators for certain tasks (544), graphics adapters (550), and so forth. These devices, along with Read-only memory (ROM) (545), Random-access memory (546), internal mass storage such as internal non-user accessible hard drives, SSDs, and the like (547), may be connected through a system bus (548). In some computer systems, the system bus (548) can be accessible in the form of one or more physical plugs to enable extensions by additional CPUs, GPU, and the like. The peripheral devices can be attached either directly to the core's system bus (548), or through a peripheral bus (549). In an example, the screen (510) can be connected to the graphics adapter (550). Architectures for a peripheral bus include PCI, USB, and the like.

CPUs (541), GPUs (542), FPGAs (543), and accelerators (544) can execute certain instructions that, in combination, can make up the aforementioned computer code. That computer code can be stored in ROM (545) or RAM (546). Transitional data can also be stored in RAM (546), whereas permanent data can be stored for example, in the internal mass storage (547). Fast storage and retrieval to any of the memory devices can be enabled through the use of cache memory, that can be closely associated with one or more CPU (541), GPU (542), mass storage (547), ROM (545), RAM (546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (500), and specifically the core (540) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (540) that are of non-transitory nature, such as core-internal mass storage (547) or ROM (545). The software implementing various aspects of the present disclosure can be stored in such devices and executed by core (540). A computer-readable medium can include one or more memory devices or chips, according to particular needs. The software can cause the core (540) and specifically the processors therein (including CPU, GPU, FPGA, and the like) to execute particular processes or particular parts of particular processes described herein, including defining data structures stored in RAM (546) and modifying such data structures according to the processes defined by the software. In addition or as an alternative, the computer system can provide functionality as a result of logic hardwired or otherwise embodied in a circuit (for example: accelerator (544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method for computing semantic perception information in a media application server (Media AS), including: receiving, from a user equipment (UE) including at least one sensor, at least one piece of sensor information that is captured by the at least one sensor and associated with a three-dimensional (3D) space; generating a representation of the 3D space including at least one object based on the received at least one piece of sensor information; and generating at least one piece of semantic perception information of the at least one object.

(2) The method of feature (1), in which the at least one piece of semantic perception information includes at least one of a semantic map, a label, or a scene graph.

(3) The method of feature (1) or (2), further including: transmitting the at least one piece of semantic perception information to the UE as a part of transmission of the representation of the 3D space.

(4) The method of any one of features (1) to (3), in which the UE renders the at least one object using the at least one piece of semantic perception information.

(5) The method of any one of features (1) to (4), in which: the at least one object includes a plurality of objects in the 3D space; the at least one piece of semantic perception information includes a semantic map; and the semantic map corresponds to a structured representation of the plurality of objects in the 3D space and spatial relationships of the plurality of objects in the 3D space.

(6) The method of any one of features (1) to (5), in which: the at least one object includes a plurality of objects in the 3D space; the at least one piece of semantic perception information includes a semantic map; and the semantic map includes an array of the plurality of objects in the 3D space, each of the plurality of objects including at least one of a label, a position, or a confidence score.

(7) The method of any one of features (1) to (6), in which the at least one piece of semantic perception information includes a label; and the label corresponds to a semantic label assigned to the at least one object in the 3D space.

(8) The method of any one of features (1) to (7), in which: the at least one object includes a plurality of objects in the 3D space; the at least one piece of semantic perception information includes a plurality of labels assigned to the plurality of objects; the plurality of labels is formatted in a string array; and the string array includes a mapping between a plurality of indices and the plurality of labels assigned to the plurality of objects in the 3D space.

(9) The method of any one of features (1) to (8), in which: the at least one object includes a plurality of objects in the 3D space; the at least one piece of semantic perception information includes a scene graph; and the scene graph corresponds to a graph of the plurality of objects in the 3D space with semantic relationships, the semantic relationships including at least one of adjacency information or containment information.

(10) The method of any one of features (1) to (9), in which: the at least one object includes a plurality of objects in the 3D space; the at least one piece of semantic perception information includes a scene graph; and the scene graph includes a plurality of nodes representing the plurality of objects in the 3D space and a plurality of edges representing spatial or semantic relationships of the plurality of objects.

(11) The method of any one of features (1) to (10), in which: the at least one piece of sensor information is retrieved, by a source manager of the UE, from an extended reality (XR) runtime of the UE; the at least one piece of sensor information is transmitted, by the source manager of the UE, to a media access function of the UE; and the at least one piece of sensor information is transmitted, by the media access function, to the Media AS.

(12) An apparatus for computing semantic perception information, including processing circuitry that is configured to perform the method of any one of features (1) to (11).

What is claimed is:

1. A method for computing semantic perception information in a media application server (Media AS), comprising:
receiving, from a user equipment (UE) comprising at least one sensor, at least one piece of sensor information that is captured by the at least one sensor and associated with a three-dimensional (3D) space;
generating a representation of the 3D space including at least one object based on the received at least one piece of sensor information; and
generating at least one piece of semantic perception information of the at least one object.

2. The method of claim 1, wherein the at least one piece of semantic perception information includes at least one of a semantic map, a label, or a scene graph.

3. The method of claim 1, further comprising:
transmitting the at least one piece of semantic perception information to the UE as a part of transmission of the representation of the 3D space.

4. The method of claim 1, wherein the UE renders the at least one object using the at least one piece of semantic perception information.

5. The method of claim 1, wherein:
the at least one object includes a plurality of objects in the 3D space;
the at least one piece of semantic perception information includes a semantic map; and
the semantic map corresponds to a structured representation of the plurality of objects in the 3D space and spatial relationships of the plurality of objects in the 3D space.

6. The method of claim 1, wherein:
the at least one object includes a plurality of objects in the 3D space;
the at least one piece of semantic perception information includes a semantic map; and
the semantic map includes an array of the plurality of objects in the 3D space, each of the plurality of objects including at least one of a label, a position, or a confidence score.

7. The method of claim 1, wherein
the at least one piece of semantic perception information includes a label; and
the label corresponds to a semantic label assigned to the at least one object in the 3D space.

8. The method of claim 1, wherein:
the at least one object includes a plurality of objects in the 3D space;
the at least one piece of semantic perception information includes a plurality of labels assigned to the plurality of objects;
the plurality of labels is formatted in a string array; and
the string array includes a mapping between a plurality of indices and the plurality of labels assigned to the plurality of objects in the 3D space.

9. The method of claim 1, wherein:
the at least one object includes a plurality of objects in the 3D space;
the at least one piece of semantic perception information includes a scene graph; and
the scene graph corresponds to a graph of the plurality of objects in the 3D space with semantic relationships, the semantic relationships including at least one of adjacency information or containment information.

10. The method of claim 1, wherein:
the at least one object includes a plurality of objects in the 3D space;
the at least one piece of semantic perception information includes a scene graph; and
the scene graph includes a plurality of nodes representing the plurality of objects in the 3D space and a plurality of edges representing spatial or semantic relationships of the plurality of objects.

11. The method of claim 1, wherein:
the at least one piece of sensor information is retrieved, by a source manager of the UE, from an extended reality (XR) runtime of the UE;
the at least one piece of sensor information is transmitted, by the source manager of the UE, to a media access function of the UE; and
the at least one piece of sensor information is transmitted, by the media access function, to the Media AS.

12. An apparatus for computing semantic perception information, comprising:
processing circuitry configured to:
receive, from a user equipment (UE) comprising at least one sensor, at least one piece of sensor information that is captured by the at least one sensor and associated with a three-dimensional (3D) space;
generate a representation of the 3D space including at least one object based on the received at least one piece of sensor information; and
generate at least one piece of semantic perception information of the at least one object.

13. The apparatus of claim 12, wherein the at least one piece of semantic perception information includes at least one of a semantic map, a label, or a scene graph.

14. The apparatus of claim 12, wherein the processing circuitry is configured to:
transmit the at least one piece of semantic perception information to the UE as a part of transmission of the representation of the 3D space.

15. The apparatus of claim 12, wherein:
the at least one object includes a plurality of objects in the 3D space;
the at least one piece of semantic perception information includes a semantic map; and
the semantic map corresponds to a structured representation of the plurality of objects in the 3D space and spatial relationships of the plurality of objects in the 3D space.

16. The apparatus of claim 12, wherein:
the at least one object includes a plurality of objects in the 3D space;
the at least one piece of semantic perception information includes a semantic map; and
the semantic map includes an array of the plurality of objects in the 3D space, each of the plurality of objects including at least one of a label, a position, or a confidence score.

17. The apparatus of claim 12, wherein:
the at least one object includes a plurality of objects in the 3D space;
the at least one piece of semantic perception information includes a plurality of labels assigned to the plurality of objects;
the plurality of labels is formatted in a string array; and
the string array includes a mapping between a plurality of indices and the plurality of labels assigned to the plurality of objects in the 3D space.

18. The apparatus of claim 12, wherein:
the at least one object includes a plurality of objects in the 3D space;
the at least one piece of semantic perception information includes a scene graph; and
the scene graph corresponds to a graph of the plurality of objects in the 3D space with semantic relationships, the semantic relationships including at least one of adjacency information or containment information.

19. The apparatus of claim 12, wherein:
the at least one object includes a plurality of objects in the 3D space;
the at least one piece of semantic perception information includes a scene graph; and
the scene graph includes a plurality of nodes representing the plurality of objects in the 3D space and a plurality of edges representing spatial or semantic relationships of the plurality of objects.

20. A non-transitory computer readable storage medium storing instructions which, when executed by at least one processor of a media application server (Media AS), cause the at least one processor to perform:
receiving, from a user equipment (UE) comprising at least one sensor, at least one piece of sensor information that is captured by the at least one sensor and associated with a three-dimensional (3D) space;
generating a representation of the 3D space including at least one object based on the received at least one piece of sensor information; and
generating at least one piece of semantic perception information of the at least one object.
